(19) United States
(12) Patent Application Publication
(10) Pub. No.: US 2006/0205369 A1
(43) Pub. Date: Sep. 14, 2006

(54) Multiple antenna receiver system in vehicles

(75) Inventors: Peter Schaich, Kohlberg (DE); Jorg Muller, Neckartenzlingen (DE)

Correspondence Address: THE FIRM OF KARL F ROSS, 5676 RIVERDALE AVENUE, PO BOX 900, RIVERDALE (BRONX), NY, 10471-0900, US

(73) Assignee: HIRSCHMANN CAR COMMUNICATION GMBH

(21) Appl. No.: 11/369,210

(22) Filed: Mar. 6, 2006

(30) Foreign Application Priority Data
Mar. 8, 2005 (DE) 102005011036.3
Mar. 6, 2005 (DE) 102006010591.5

(51) Int. Cl. H04B 7/08; H04B 1/18; H04B 1/06

(52) U.S. Cl. 455/132; 455/152.1; 455/272

(57) ABSTRACT

A multiple-antenna system for mobile uses in vehicles with several reception paths (10, 20, 30), each reception path (10, 20, 30) being associated with at least one respective antenna (11, 21, 31) and being set up for a first frequency band and at least one second frequency band, whereby according to the invention at least a third reception path (20) is provided that has an antenna (21) and that is set up to receive at least one further frequency band, conversion means being provided that converts the frequency band of one reception path (10) into a different frequency band and duplexing means are provided for transmitting both of the signals of the two frequency bands over a coaxial cable (41), separating means being provided to put the transmitted signals back into their respective frequency bands.

The invention relates to a method of signal transmission in a multiple-antenna system as well as such a multiple-antenna system for mobile uses in vehicles with several reception paths according to the features of the preambles of the independent patent claims.

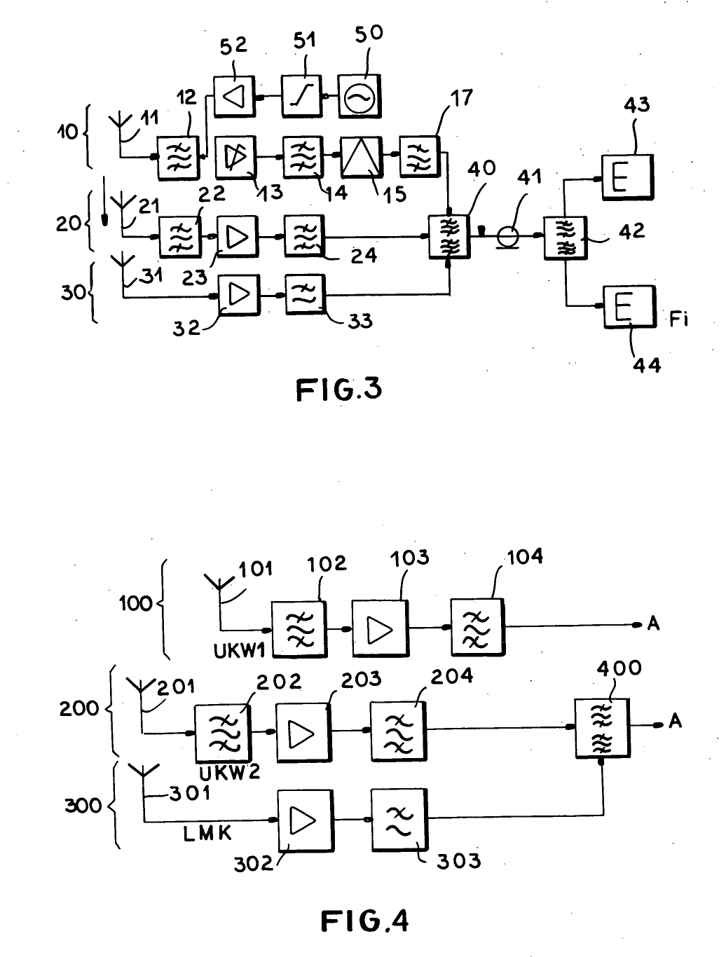

The invention is based on a multiple-antenna receiver system in vehicles, for example for receiving radio signals in the VHF and LMS frequency band (LMS=long wave, middle wave, short wave). Such a device according to the state of the art, as widely utilized at the moment, is exemplarily shown in FIG. 4. In this antenna system a plurality (e.g. three or more) of antennas is used. Each antenna signal is amplified by a suitable high frequency amplifier and adapted with respect to output impedance to the impedance of a cable. For transmitting the receiver signals between the antenna and an output A of the receiver system to a receiver (radio) an appropriately adapted coaxial cable is used.

The multiple-antenna receiver system formed in FIG. 4 according to the state of the art consists for example of three reception paths 100, 200, 300, the reception paths 100, 200 being set up for receiving VHF and the reception path 300 for LMS. The first reception path 100 comprises an antenna and a downstream band pass 102 (filter), an amplifier 103 as well as another band pass 104. The high-frequency signals received by the antenna 101 are processed accordingly and fed to an output A for further processing and reproduction of the received signals. The same applies for the reception paths 200, 300, the reception path 200 also having an antenna 201, a band pass 202, an amplifier 203, and another band pass 204. Similarly constructed is the reception path 300 that has an antenna 301, an amplifier 302 as well as a downstream band pass 303. A duplexer 400 combines the signals of the reception paths 200, 300 and feeds them to the output A for further processing and reproduction. This combination however works only in the case when the frequency bands of the one reception path 200 clearly differ from the one of the other reception path 300. This is so for example, when the frequency band of the reception path 200 (VHF) is approximately in the area of 88 to 108 MHz, while the LMS frequency band is in the area approximately of 150 kHz to 6.2 MHz. This way the two frequency bands of the reception paths 200, 300 differ by at least a factor of ten, if not even about several such factors from each other, so that the combination through the duplexer 400 is not a problem and in the further processing separation and separate reproduction of the signals connected therewith is possible. The combination of two signals of two reception paths in the same frequency band (e.g. the signals of the reception path 100 and those of the reception path 200) is basically not possible, as after combination by means of the duplexer 400 separation is not possible in the subsequent further processing and reproduction of the signals and thus a mixing of the signal contents occurs that is not desired.

Hence the transmission of several antenna signals in the same frequency band takes place through a separate line between the output of the reception path and the downstream receiver device or the device for further processing of the antenna signals. This is shown in FIG. 1 in that the reception path 100, 200 for receiving antenna signals are formed in the same frequency band (VHF) but their signals are led through separate lines to the respective output A. The use of several lines (in this case coaxial cables) results in additional costs for cables and plug-in connectors. AT the same time the risk of assembling failures, cable cuts, breaks in the plug-in connectors and the like increases, so that such a system according to the state of the art has a plurality of failure sources that can be detected only after the installation into the vehicle and its initiation. This late detection of failures is of a considerable disadvantage as the fault repair is thereby very complex since the individual components of the total system are not readily accessible anymore after their installation into the vehicle.

Thus, it is the object of the invention to further form a multiple-antenna receiver system and a corresponding method for mobile uses in vehicles with several reception paths, such that the complexity of the signal processing and the therefore required devices is clearly reduced, especially cables and plug-in connectors shall be saved. Moreover with the design of the multiple-antenna receiver system according to invention also the risk of occurring failures, i.e. failure sources, shall be eliminated.

This object is solved by the features of the independent patent claims.

According to invention a method for signal transmission in a multiple-antenna system is proposed that is characterized in that the frequency band of a reception path is converted into a frequency band differing from the other frequency band, the signals of the respective frequency bands being transmitted through a coaxial line and the transmitted signals are separated again into their respective frequency bands or are just further processed in the converted band as well as are then fed back to a receiver.

The conversion of the one frequency band into another frequency band clearly differing from the first frequency band, for example by utilizing a frequency multiplexing method, makes it possible to send the antenna signals of different antennas of the respective reception paths through a shared antenna line (coaxial line). To this end for example the signals received by an antenna are converted into another frequency band and transmitted together with the signals of another antenna, otherwise operating in the same frequency band (frequency range), on a single line. At the same time it is further provided that after the transmission through the preferred single coaxial line the antenna signals transmitted together are separated form each other and are further processed at receiver (e.g. through a radio). This further processing, e.g. converting the received high frequency signals into low frequency signals to be reproduced and if needed processing and representing for use contents of the signals, is already known but not subject matter of the invention.

Thus, the method according to invention has the advantage that signals from the same frequency band but different reception paths can be transmitted through a single coaxial line, so that the complexity for cables and plug-in connectors is clearly reduced and therewith also the failure sources of the total system are reduced.

In the further embodiment of the invention it is provided that the multiple-antenna system performs a diagnosis in which a test signal especially a test signal spectrum is generated, sent through at least one of the antennas, received by at least one of the other antennas, especially all of the other antennas, and fed to the respective reception path and analyzed at its end. Here the possibility is given in an advantageous way that the multiple-antenna system generates a testing signal by itself and thereby at least one of the antennas is used as sender antenna. If this sender antenna transmits the testing signal on request of a user it is received by the remaining other antennas and processed in the usual way through the downstream reception paths. At the end of a respective reception path an analysis can take place, especially through a comparison of the transmitted testing signal to the received signal at the end of the respective reception path. By this comparison one can detect whether the respective reception path is correctly received and processed as well as transmitted on. If this is not the case the presence of a failure (e.g. cable cut, defect of a filter of an amplifier or of any element in the reception path) can be presumed. If such a failure is detected it can be repaired prior to the installation of the multiple-antenna system into the vehicle or this system can simply not be installed in the vehicle. Alternatively the systems are assembled and tested right in the vehicle. This way it is possible to test before housings etc. are arranged or (what is also usual) a final testing is performed and then a detected failure is eliminated. Therewith the method according to invention renders diagnosis more clear in a very advantageous manner.

Further the invention proposes especially for realization of the above described methods a multiple-antenna system for mobile utilizations in vehicles with several reception paths characterized in that at least a third reception path is provided wherein the reception path has at least one antenna and is formed for receiving at least another frequency band wherein conversion means are provided to convert the frequency band of a reception path into a frequency band differing from the at least two other frequency bands, and combination means are provided to transmit the signals of the respective frequency bands through a coaxial line, further separation means being provided that separate the transmitted signals again into their respective frequency bands.

Here the invention proposes solving the object in an advantageous multiple-antenna system with which the signals of two equal frequency bands (e.g. VHF) can be transmitted through a single line.

Moreover it is possible that only a single coaxial line is used or e.g. in diversity systems, that e.g. the signals of two antennas that are arranged in the front of the car, are transmitted through a single coaxial line and further the antenna signals that are received in the back of the car are transmitted through another single coaxial line to a receiver.

The multiple-antenna system according to invention is further described in the dependent claims and explained with the following description and the figures.

Therein:

FIG. 1 is a multiple-antenna system according to invention with several reception paths;

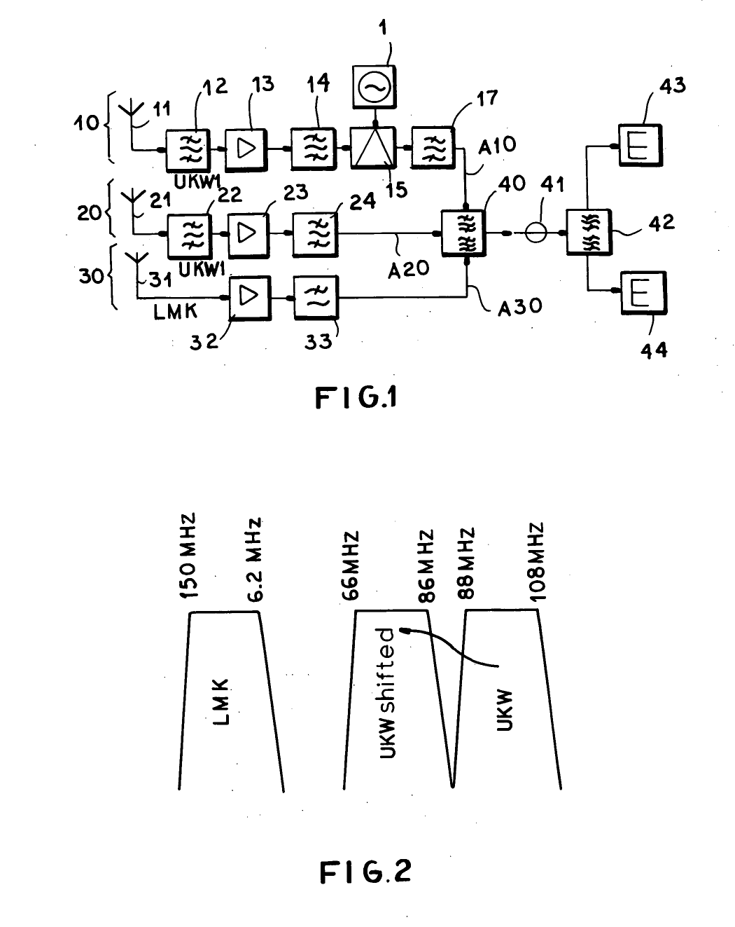

FIG. 2 is a frequency plan;

FIG. 3 is a multiple-antenna system with a diagnosis possibility.

FIG. 1 shows a multiple-antenna system for the mobile use in vehicles that has in this embodiment three reception paths 10, 20, 30. The invention can be carried out also with a multiple-antenna system that has only two reception paths 10, 20 or also more than the three represented reception paths. The reception path 10 includes in a known way an antenna 11, a filter (band pass 12), a regulated amplifier 13 as well as another band pass 14. For realization of the invention, especially for carrying out the frequency multiplexing method, a mixer 15 and an oscillator 16 are connected in the reception path 10. Finally in this reception path 10 a further filter (band pass 17) is connected. The amplifier 13 should preferably be regulated to prevent too strong modulation of the mixer.

The second reception path 20 has also an antenna 21, a band pass 22, an amplifier 23 as well as another band pass 24.

Both reception paths 10, 20 are set up for receiving two the same frequency band (here for example VHF) so that the antennas 11, 21 either can receive the signals of a single sender, but with different receiver quality, or the signals of two different senders in this frequency band.

Finally at least a third reception path 30 with antenna 31, amplifier 32 and filter (band pass 33) is present. This third reception path 30 is formed in this example of design for receiving LMS signals, but can be formed also analogously to the reception path 10 for VHS receiving.

The outputs A 10, A 20, A 30 of the reception paths 10, 20, 30 have downstream as combination means for example a duplexer 40 that is connected output-side to a coaxial cable 41 for signal transmission. Downstream of the coaxial cable 41 is as separation means another duplexer 42 the output signals of which are fed to the receivers 43, 44.

One of the two receivers contains also the device for LMS receiving (after another duplexer). Hence, the one duplexer could be provided with three outputs and three receivers for the respective received frequency bands could be downstream.

To be able to perform the conversion of the one frequency band into a frequency band differing from the at least two other frequency bands, the mixer 15 and the oscillator 16 are present as conversion means for example here in the reception path 10. By means of these elements the original frequency band of the reception path 10 is converted into a frequency band differing therefrom that also differs from the frequency bands of the reception paths 20, 30. This way the frequency bands (frequency areas) at the outputs A 10, A 20, A 30 clearly differ from each other, especially when they are remote from each other by factors of ten. If these different frequency bands are transmitted through the combination means formed as duplexer 40 for example by means of a frequency multiplexing method through the coaxial line 41, no mutual interference or override occurs, so that separation by means of the separation means formed also as duplexer 42 can be performed easily at the output of the duplexer 42 and the original frequency bands of the reception paths 10, 20, 30 are available again for further processing in the downstream receivers 43, 44.

FIG. 2 shows a frequency plan by means of which the conversion of the frequency band of a reception path (for example the reception path 10) is carried out in such a frequency band, which is an unused frequency band for the multiple-antenna system. For the reception path 30 no conversion is required since this LMS frequency band is for example in the area between 150 kHz and 6.2 MHz. The frequency bands of the reception paths 10 and 20 are in the VHF area, for example between 88 MHz and 108 MHz. Here the frequency bands of these two reception paths 10, 20 overlap, so that they cannot be transmitted without interference or mutual override through a single coaxial line without the method according to invention. Hence, the invention proposes to transform by means of the conversion means (15, 16) the frequency band of the one reception path 10 into a shifted frequency band. This takes place for example in that the frequency band of the reception path 10 is shifted into a frequency band between 66 MHz and 86 MHz (in FIG. 2 referred to as VHF-shifted). This shifted frequency band is for example separated by a factor of 10 from the LMS frequency band and also separated from the frequency band of the second reception path 20. This way the invention allows that the output signals of the three reception paths 10, 20, 30 to be transmitted through a single coaxial line 41 without mutual interferences or overrides. Moreover after the transmission separation of the single transmitted frequency areas from the transmitted spectrum is thereby possible offhand.

The at least two, preferred three frequency bands are transmitted for example through the coaxial line and then separated again by means of frequency-dependent duplexers.

It should be noted that the frequency plan shown in FIG. 2 is merely exemplary. Thus, especially for the frequency bands also other frequency bands are possible, if not LMS or VHF frequencies are concerned. Thus, the given upper and lower boundaries of the respective frequency bands can also differ from each other as well as their widths depending on which standard in which country is broadcast and received with the multiple-antenna system. Also the shifted frequency area does not have to be between the two exterior frequency areas but can (in viewing FIG. 2) be shifted more to the right (more remote from 108 MHz). Also the distance of the shifted frequency band to one of the other frequency bands can be smaller than a decimal power or be greater than the exemplarily shown 2 MHz. To this end for example tracking filters are used in the antennas.

FIG. 3 shows based on the multiple-antenna system according to FIG. 1 a multiple-antenna system with a diagnosis system. Besides the elements already shown in FIG. 1 and provided with the same reference numbers, the multiple-antenna system according to FIG. 3 has an oscillator 50, a limiter 51 generating for example from a sinus signal a ridge spectrum, as well as an amplifier 52 by means of which through limiting (limiter 51) and amplifying (by means of amplifier 52) a test signal is generated. Herein for example a test signal spectrum is concerned, preferably a ridge spectrum, which also is in the VHF frequency band. The output signal of the amplifier 52 is fed after filtering by the band pass 12 to the antenna 11 that is used to this end as a transmitting antenna (in the mode instead of its function as receiver antenna for the reception path 10). This broadcast test signal, since it is in the same frequency band in which the reception path 20 is formed for receiving, it is also received from the antenna 21 of the reception path 20, if need be with a certain transmission attenuation. This received testing signal can now be transmitted and processed in a known way through the reception path 20, the means 40, 41, 42 and fed to the associated receiver 42, 44. In the associated receiver now the receiver field intensity, the level or miscellaneous parameters of the broadcast and received testing signal can be determined and with it a decision be made whether the passed reception path (here for example 21 to 24, 40 to 42), i.e. the associated high-frequency transmission path, is acceptable or if failures are present. In a possible example of design for example the receiver 43 is set up to control the testing signal generation by means of 50 to 52, which includes also that the generated testing signal is applied to an input of the band pass 12 and thereby for example the connection between the band pass 12 and the amplifier 13 is disrupted. At the same time the receiver 43 has to know the generated testing signal (e.g. frequency, level or the like) to be able to compare it to the output signal received and transmitted from here for example the second reception path 20. With such a set/actual comparison of the testing signal that is generated by means of 50 to 52 and the output signal transmitted from 21 to 24 and 40 to 42 taking into account eventually further parameters (such as the known transmission attenuation of the reception path 20) it can be detected if the reception path 20 operates properly or if failures are present there. Depending on the result of the set/actual comparison a possible failure can be concluded. If e.g. no testing signal arrives at all possibly a total defect of an electronic unit in the reception path, a cable cut, a not plugged plug-in connector of the like is to be considered. Depending on how the transmitted testing signal is distorted another defect of one of the electronic units in the reception path 20 can be detected.

The filters that are connected in the multiple-antenna system according to FIG. 1 and 3, are preferably all band passes for letting pass only the used frequency areas and for blocking signals below and above of these used frequency ranges. To this end the filters, especially the band passes, are formed as steep filters to realize a sharp signal separation. This way it is possible to form these steep filters, especially the steep band passes, as ceramic filters that have the required steepness in the filtering. Further it is advantageous when the oscillator 16 according to FIG. 1 for conversion purposes is also used for generating of the test signal. That means that the oscillator 16 in FIG. 1 can be equivalent to the oscillator 50 in FIG. 3. Hence a switching has to take place namely that the oscillator first gives its signals to the mixer 15 (in FIG. 1) and then switches to the filter 51 for testing purposes (in FIG. 3). This switching can be carried out for example automatically by one of the receivers 43 or 44 or in any ways by a user.

Regarding the design of the multiple-antenna system with diagnosis possibility according to FIG. 3 it shall be noted that the reception path 30 (or even further reception paths not shown here) can also be formed for receiving signals in the VHF area. In this case for example the testing signal generated and broadcast by the reception path 10 would be able to be processed and tested from both the reception path 20 and the reception path 30 (or further equal-type reception paths). Also it is possible that all reception paths are not formed for VHF-receiving but for LMS-receiving so that this applies with respect to VHF-receiving and its diagnosis also for other frequency bands, especially the LMS frequency band. Moreover the possibility shall be noted that with more than three reception paths for the same frequency band also more than one reception path for transforming into other frequency bands can be formed, which are unused frequency bands for the multiple-antenna system. Thus, it would be possible with three or more reception paths in one and the same frequency band that their output signals, despite which one remains original, are converted into other frequency bands that are unused frequency bands and differ from each other and are transmitted through the coaxial line. Through the downstream duplexer then the separation for the individual receivers is no problem anymore. This means with three reception paths in the VHF area that the first reception path maintains its frequency area (e.g. 88 MHz to 108 MHz) and gives its output signal to the combination means (here duplexer 40). The second reception path comprises the conversion means that shift the received frequency area e.g. into the area of 66 MHz to 86 MHz. This shifted frequency area is then also fed to the duplexer 40. The third frequency area comprises also conversion means that transform the frequency area of this reception path for example into a frequency area from 44 MHz to 64 MHz wherein this converted frequency area is then also fed to the duplexer 40. Further reception paths with corresponding conversion means and conversions of the frequency band into frequency bands differing from the above-mentioned frequency bands, all of which are no use frequency band, are also possible.

With respect to FIG. 2 it is noted that the conversion into the shifted frequency band from 66 MHz to 86 MHz shown there is therefore especially advantageous since usual receiver components present in serial use can process VHF frequencies from about 65 MHz. However, this is no limitation so that also frequency bands in areas below of 65 MHz and also above of 108 MHz can be shifted. In this case it is to be expected that the corresponding receiver components, especially the receiver 43, 44 are formed for processing of these frequencies.

### LIST OF REFERENCES

10 reception path
11 antenna
12 band pass
13 amplifier
14 band pass
15 mixer
16 oscillator
17 band pass
20 reception path
21 antenna
22 band pass
23 amplifier
24 band pass
30 reception path
31 antenna
32 amplifier
33 band pass
40 duplexer
41 coaxial cable
42 duplexer
43 receiver
44 receiver
50 oscillator
51 filter
52 amplifier
100 reception path
101 antenna
102 band pass
103 amplifier
104 band pass
200 reception path
201 antenna
202 band pass
203 amplifier
204 band pass
300 reception path
301 antenna
302 amplifier
303 band pass
400 duplexer
A output

1. A multiple-antenna system for mobile uses in vehicles with several reception paths (10, 20, 30), each reception path (10, 20, 30) being associated with a respective antenna (11, 21, 31) and being set up for a first frequency band and at least one second frequency band, characterized in that conversion means is provided that converts the frequency band of one reception path (10) into a different frequency band and duplexing means are provided for transmitting both of the signals of the two frequency bands over a coaxial cable (41), separating means being provided to put the transmitted signals back into their respective frequency bands.

2. The multiple-antenna system according to claim 1, characterized in that the converting means is formed as a mixer (15) and oscillator (16).

3. The multiple-antenna system according to claim 1, characterized in that the duplexing means is formed as a frequency splitter (40).

4. The multiple-antenna system according to claim 1, characterized in that the separating means is formed as a frequency splitter (42).

5. The multiple-antenna system according to claim 1, characterized in that the converting means that changes the frequency band of one of the reception paths into another frequency band, is set up to convert into a frequency band for which the multiple-antenna system is not tuned.

6. The multiple-antenna system according to claim 1, characterized in that the receiver has at least one filter, in particular a band-pass filter.

7. The multiple-antenna system according to claim 1, characterized in that the filter is a high-pass filter.

8. The multiple-antenna system according to claim 6, characterized in that the filter is a ceramic filter.

9. The multiple-antenna system according to claim 1, characterized in that a receiver is provided with an oscillator for generating a test signal for diagnostic purposes, this output signal is sent to the antenna of this receiver to be transmitted thereby.

10. A method of transmitting signals in a multiple antenna system for mobile uses in vehicles with multiple reception paths (10, 20, 30), each reception path (10, 20, 30) being associated with a respective antenna and being set up for receiving a first frequency band and at least one second frequency band, characterized in that the frequency band of one of the reception paths (10) is converted into a different frequency band the signals of the frequency bands are transmitted together via a common coaxal cable (410, and the transmitted signals are separated into their respective frequency bands and fed to a receiver.

11. The method according to claim 10, characterized in that the conversion is done by frequency multiplexing.

12. The method according to claim 10 characterized in that in that for diagnosing the multiple-antenna system a test signal, in particular a test-signal spectrum, is produced that is transmitted over at least one of the antennas and that is received by at least one and in particular by all of the other antennas and fed to the respective reception paths and evaluated at the ends thereof.
